(19) United States
(12) Patent Application Publication
(10) Pub. No.: US 2026/0172507 A1
(43) Pub. Date: Jun. 18, 2026

(54) Personalization for Customer Experience

(71) Applicants: Slava Zhakov, Incline Village, NV (US); Slava Sayko, Walnut Creek, CA (US); Tod Famous, Ayer, MA (US)

(72) Inventors: Slava Zhakov, Incline Village, NV (US); Slava Sayko, Walnut Creek, CA (US); Tod Famous, Ayer, MA (US)

(21) Appl. No.: 18/979,038

(22) Filed: Dec. 12, 2024

(51) Int. Cl. H04M 3/493; G06N 3/0475; H04M 3/51

(52) U.S. Cl. CPC H04M 3/4936; G06N 3/0475; H04M 3/5175; H04M 2203/551

(57) ABSTRACT

A method for producing a positive customer experience (CX) has steps receiving an incoming communication from a customer by a software-enabled Virtual Assistant (VA) in a contact center, initiating a dialogue, identifying by the VA a unique identity for the customer, preparing and delivering a greeting to the customer by the VA, the greeting comprising one or more elements reflecting a circumstance or characteristic of the customer, continuing by the VA to personalize VA contributions to the dialogue until terminating the dialogue, and, if the communication is voice, monitoring contributions to the dialogue by the customer for voice characteristics, storing determined characteristics in a customer profile (CP) dedicated to the person.

### BACKGROUND OF THE INVENTION

### 1. Field of the Invention

The present invention is in the technical field of systems for serving customers interacting with commercial sites and pertains more particularly to training and evolving a virtual assistant.

### 2. Description of Related Art

The present invention leverages artificial intelligence (AI) in commercial transactions. The use of Artificial Intelligence (AI) in interaction with customers by commercial sites is rather well known in the art and is an area of considerable interest at the time of filing the instant patent application. A general treatment of AI in customer experience (CX) is provided by a Forrester report “Generative AI Essentials For CX Leaders-Answers To CX Pros'Top Questions About Generative AI” published Sep. 25, 2023, which may be downloaded from: https://reprints2.forrester.com/#/assets/2/145/RES179890/report.

Other sources of information regarding Generative Artificial Intelligence (GenAI) are established companies involved in developing and providing systems in the technical field. One such company is NICE Ltd. Originally founded in Israel in 1986 as Neptune Intelligence Computer Engineering (NICE). This Company was since renamed (1991) NICE Systems Ltd with the acronym no longer in active use, and is now known as simply NICE Ltd. AnNice Ltd. has company locations in many countries including the US.

TNice Ltd. is one of the older established firms now engaged in systems for CX, and provides a system known as CXone. There are many other firms engaged in this technology, including Crescendo.ai, founded by inventors of the instant patent application. A good idea of the present state of the technology and related art may be accessed through the website of Crescendo.ai.

The present inventors believe that augmented AI is the future of CX, and that what is needed in the art now is innovation in development and evolution of a virtual assistant in interacting with customers. Conventional customer experience lacks personalization that used to be the signature of small, personalized businesses. It is well known that customers appreciate being treated as unique human beings with personalized needs and preferences.

### BRIEF SUMMARY OF THE INVENTION

In an embodiment of the invention a method of producing a positive customer experience (CX) is provided, comprising receiving an incoming communication from a customer by a software-enabled Virtual Assistant (VA) in a contact center, initiating a dialogue, identifying by the VA a unique identity for the customer, preparing and delivering a greeting to the customer by the VA, the greeting comprising one or more elements reflecting a circumstance or characteristic of the customer, continuing by the VA to personalize VA contributions to the dialogue until terminating the dialogue, and if the communication is voice, monitoring contributions to the dialogue by the customer for voice characteristics, storing determined characteristics in a customer profile (CP) dedicated to the person.

In one embodiment the incoming communication is from a new customer, comprising determining a unique identity for the customer and setting up the customer profile. Also, in one embodiment the method further comprises evolving the customer profile for the customer over time by storing call history, purchase history, payment history, and conversation history. In one the voice characteristics comprise one or more of volume, speech rate, use of idioms, gender, age, and formal or informal speech. And in one embodiment the method further comprises storing background information associated with the customer, the background information comprising one or more of political affiliation, religion, geographic region, level of education, alma mater, weather in region, and local sports teams.

In one embodiment the method further comprises executing background searches on the Internet network finding and storing in the customer's CP the background information returned in the searches. Also, in one embodiment the method further comprises continuing over subsequent communications from the same customer to monitor the customer's contributions to the dialogue for personal characteristics and storing determined personal characteristics in the customer's CP. In one embodiment the method further comprises continuing over subsequent communications from the same customer to personalize the VA's contributions to the dialogue by reference to the customer's CP, using one or more generative artificial intelligence (AI) algorithms. In one embodiment the communication is voice communication, comprising generating VA contributions as electronic signals suitable for telephony transmission. And in one embodiment the communication is text, comprising generating VA contributions as text signals suitable for network transmission.

In one embodiment of the invention a system for producing a positive customer experience (CX) is provided, comprising a software-enabled Virtual Assistant (VA) in a contact center, initiating a dialogue with a customer initiated by an incoming communication from the customer, and a customer profile associated with the customer, originated at a first call from the customer, and associated with a unique identity for the customer, wherein the VA delivers a greeting to the customer, the greeting personalized by comprising one or more elements reflecting a circumstance or characteristic of the customer, wherein the VA continues to personalize VA contributions to the dialogue until terminating the dialogue, and wherein the VA, if the communication is voice, monitors contributions to the dialogue by the customer for voice characteristics, storing determined characteristics in a customer profile (CP) dedicated to the person.

In one embodiment of the system the incoming communication is from a new customer, and the VA determines a unique identity for the customer and sets up the customer profile. Also, in one embodiment the customer profile is evolved over time and subsequent calls from the same customer by storing call history, purchase history, payment history, and a conversation history. Also, in one embodiment the voice characteristics comprise one or more of volume, speech rate, use of idioms, gender, age, and formal and informal speech.

In one embodiment of the system background information associated with the customer is stored in the CP, the background information comprising one or more of political affiliation, religion, geographic region, level of education, alma mater, weather in region, and local sports teams. Also, in one embodiment the system further comprises a search engine executing background searches on the Internet network, finding and storing in the customer's CP the background information returned in the searches. Also, in one embodiment the VA continues over subsequent communications from the same customer to monitor the customer's contributions to the dialogue for personal characteristics and stores determined personal characteristics in the customer's CP. Also, in one embodiment the VA continues over subsequent communications from the same customer to personalize the VA's contributions to the dialogue by reference to the customer's CP, using one or more generative artificial intelligence (AI) algorithms. In one embodiment the communication is voice communication, and the VA generates VA contributions to the dialogue as electronic signals suitable for telephony transmission. And in one embodiment the communication is text, wherein the VA generates VA contributions to the dialogue as text signals suitable for network transmission.

### BRIEF DESCRIPTION OF THE SEVERAL VIEWS OF THE DRAWINGS

FIG. 1 is an architectural diagram illustrating a communication network, including a contact center in an embodiment of the present invention.

FIG. 2 illustrates a virtual assistant (VA) interacting with a customer in an embodiment of the invention.

FIG. 3 is a diagram depicting elements of customer profiles in an embodiment of the invention.

FIG. 4 is a flow diagram illustrating a process in an embodiment of the invention.

### DETAILED DESCRIPTION OF THE INVENTION

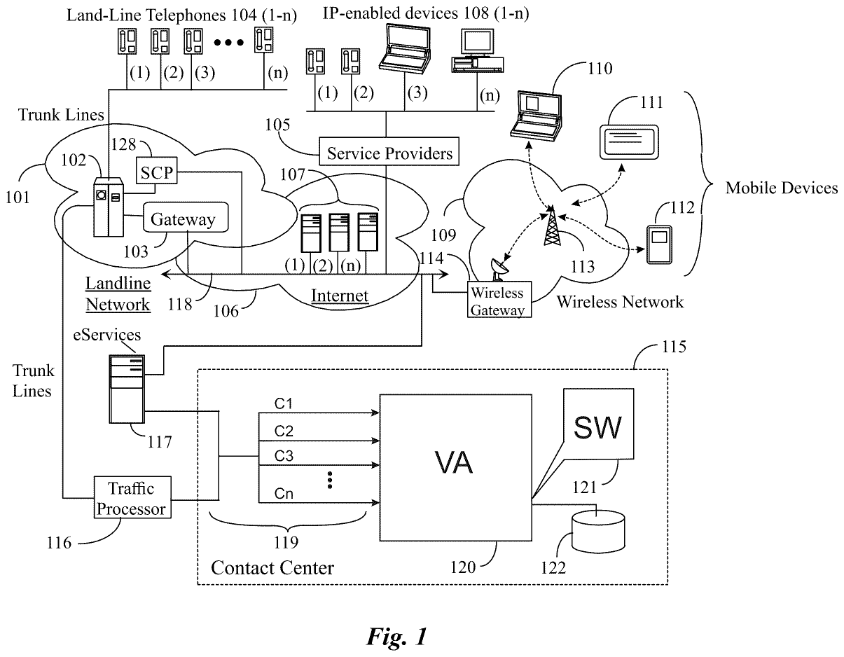

FIG. 1 is an architectural diagram illustrating a contact center 115 and a plurality of networks with interconnections whereby customers may interact with the contact center. Contact center 115 may be hosted by one enterprise or by more than one enterprise, and one enterprise may employ more than one contact center. Customers may interact with contact center 115 through communication appliances such as land-line telephones 104(1-n), IP-enabled devices 108(1-n), or through mobile appliances 110, 111 or 112. In some circumstances interaction may be limited to voice, but in other circumstances interaction may include text interaction, such as, for example, email, messaging services chat, video interaction, data services, and so on.

Persons interacting through land-line telephones 104 may connect firstly over trunk lines as shown through a land-line network 101 to a network switch 102. Switch 102 may interact with hardware and software of a Service Control Point (SCP) 128, which may execute intelligent operations to determine to connect an incoming call to different ones of available contact centers. Incoming calls in some circumstances may also be routed through a gateway 103 into the well-known Internet network 106 as packet-switched calls. The interconnections in the Internet are represented by backbone 118. In this circumstance such a call may be further processed as a packet-switched IP call. Equipment providing SCP services may also connect to the Internet and may allow SCP functionality to be integrated with Internet-connected servers and intelligence at contact centers.

A call from a land-line telephone 104 connecting to switch 102 may be routed to contact center 115 via trunk lines as shown to a Traffic Processor 116. Traffic processor 116 may provide Session Border Control (SBC) functionality, may operate as a Media Gateway, or as a SoftSwitch.

Persons interacting through IP-enabled devices 108(1-n) may interact through the Internet network via backbone 118, enabled by a variety of Internet service providers (ISPs) 105 which operate to provide Internet service for such devices. Devices 108(1) and 108(2) may be IP-enabled telephones, operating under a protocol such as Session Initiation Protocol (SIP). Appliance 108(3) is illustrated as a lap-top computer, which may be enabled by software for voice communication over packet networks such as the Internet, and may also interact in many other ways, depending on installed and operable software, such as Skype™. Similarly, appliance 108(n) illustrated as a desktop computer, may interact over the Internet in much the same manner as laptop appliance 108(3).

Many IP-enabled devices provide capability for users to interact both in voice interactions and text interactions, such as email, text messaging services and chat protocols. Internet 106 may comprise a substantial variety of Internet-connected servers 107 and IP-enabled devices with Internet access may connect to individual ones of such servers to access services provided. Servers 107 in the Internet may comprise email servers, text messaging servers, social networking servers, Voice over IP (VoIP).

IP-enabled devices and mobile devices communicating through gateways to the Internet connect to contact center 115 through an eServices server 117

Another arrangement by which users and agents may interact with contact centers is through mobile devices, illustrated in FIG. 1 by devices 110, 11 and 112. Such devices may include, but are not limited to, laptop computers, Pad devices and smart telephones. Such devices are not limited by a land-line connection or by a hard-wired Internet connection as shown for telephones 104 or IP-enabled devices 108 and may be used by customers from changing geographic locations and while in motion. Devices 110, 111 and 112 are illustrated in FIG. 1 as connecting through a wireless network 109, which may occur through individual ones of cell towers 113 associated with base stations having gateways such as gateway 114 illustrated, the gateways connected to Internet backbone 118.

In some circumstances mobile devices, such as devices 110, 111 and 112 may connect to supplemental equipment operable in a moving vehicle. For example, cellular smartphones may be enabled for near-field communication such as Bluetooth™, and may be paired with equipment in an automobile, which may in turn connect to the Internet network through satellite equipment and services, such as On-Star™. Wireless communication may be provided as well in aircraft, which may provide an on-board base station, which may connect wirelessly to the Internet through either a series of ground stations over which an aircraft may pass in flight, or through one or more satellites.

Regardless of the variety of ways that Internet access may be attained by mobile devices, users of these devices may leverage Internet-connected servers for a variety of services, or may connect through the Internet more directly to a contact center such as contact center 115, where users may interact as customers of the host of the contact center.

Contact center 115 may represent one of a plurality of federated contact centers, a single center hosted by a single enterprise, a single contact center operating on behalf of a plurality of host enterprises, or any one of a variety of other arrangements. Architecture of an individual contact center 115 may also vary considerably, and not all variations may be illustrated in a single diagram such as FIG. 1, which is exemplary. The architecture and interconnectivity illustrated in FIG. 1 is exemplary.

As described above, contact center 115, and the architecture and connectivity of the networks through which transaction is accomplished between customers is exemplary, and there are a variety of ways that similar functionality might be attained with somewhat different architecture.

Traffic Processor 117 managing landline calls and eServices server 117 both route incoming calls into contact center 115 on interconnections 119 to a Virtual Assistant (VA) 120 that is of importance to the present invention. VA 120 is powered by a software set 121 that comprises conventional algorithms as well as AI algorithms, and interacts with a data repository 122 that comprises customer specific data.

VA 120 receives communication from customer 1 (C1), customer 2 (C2), customer 3 (C3) and from a plurality of further customers through customer n (Cn). VA 120 interacts with each connected customer at any point in time in a fashion unique to each individual customer. As depicted in FIG. 1 the skilled person may assume that there is just one VA 120 that interacts with all customers. In actuality the VA interacts with each customer in a unique way. For purposes of this disclosure interactions of the VA with customers will be described below in individual cases.

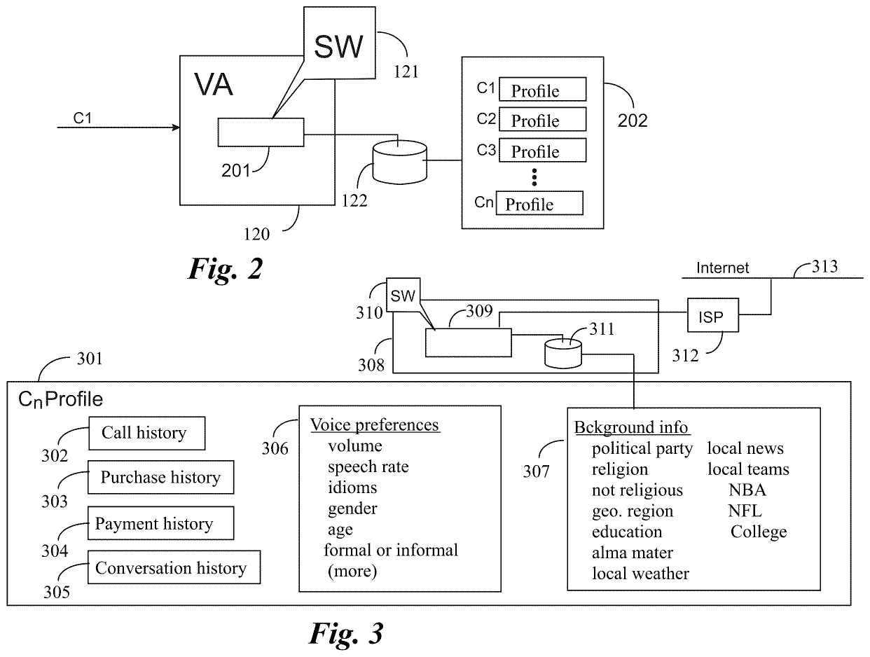

FIG. 2 illustrates VA 120 interacting with a customer C1, and the incoming communication is a telephone call. Whether the call connects as a landline call or an Internet enabled call is not material for purposes of teaching the operation of the VA. A processor 201 is shown as interacting with the call, and the processor is coupled to a data repository 122, which stores, among other information, a plurality 202 of customer profiles, listed as C1 Profile, C2 Profile, C3 Profile through Cn Profile. Every known customer of the host enterprise has a profile that is accessed every time a customer calls and is updated with new information from each customer call.

FIG. 3 is a diagram illustrating some elements of a customer profile 301. The customer profile shown is for a customer n, and comprises in this example call history 302, purchase history 303, payment history 304, conversation history 305 and voice preferences 306. Voice preferences 306 may be developed over a plurality of calls by noting the customer's usage, and by customer statement of preferences, for example. These preferences are used in guiding generative AI algorithms to produce speech for the VA, both in initiative speech, and in responsive speech in a conversation.

In managing conversations with customers, generating voice for the VA, for a best customer experience the generative AI needs to know as much about the customer as may reasonably be determined. For example, there are categories and characteristics for individuals that might be noted in preparing voice statements for the VA. It may be important in some circumstances to know if the customer is a registered Democrat or Republican, the extent of political participation, religion, lack of religion, local weather, local news, local colleges, NBA teams nearby, NFL teams, whether the customer is an avid fan of one or more teams, the customers education, alma mater, musical interests and ability, and much more.

In one embodiment a background information set 307 is associated with each customer profile. The categories in information set 307 are exemplary, and may be complete for some customers, and partial for others, or empty for some, particularly newer customers. The information in each category may be garnered over a number of calls with a customer by query or by customer declaration. In one embodiment a background system 308 operates to find information for set 307. In system 308 a processor 309 executes software (SW) 310 and stores information in a data repository 311. Processor 309 is coupled to an Internet Service Provider (ISP) 312, which provides connection to the well-known Internet network 313. Processor 309 operates in background searching Internet sources for reliable information about customers identified as customers of the host enterprise. In such an operation it is critical that the system be sure that the information collected and saved is for the actual customer, as mistakes could in some circumstances be troublesome.

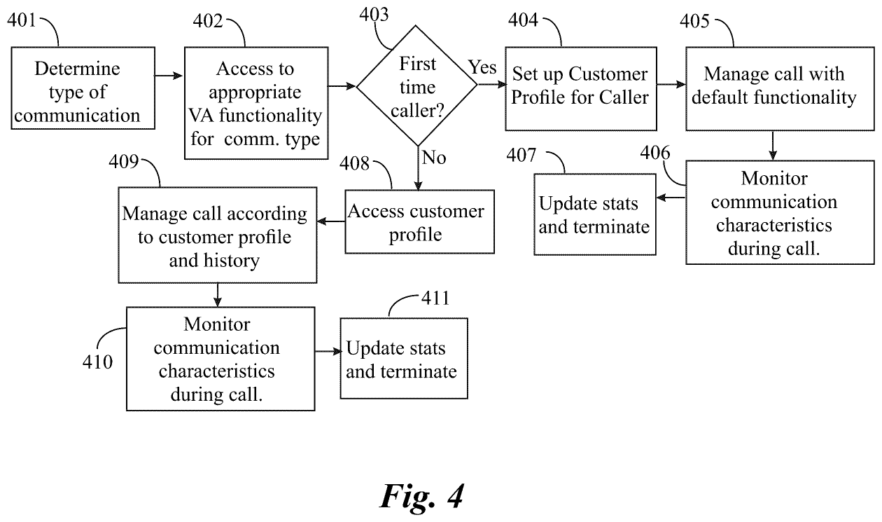

FIG. 4 is a flow diagram depicting steps in a process by the VA upon receiving a communication as shown in FIG. 2. At step 401 the system determines the type of communication. Referring back to FIG. 1 it may be seen that the communication may be a land-line call, a cellular call, an Internet packet-switched call, a chat session, or a text message. The type of call may or may not be important to the way the VA interacts. For example, if the incoming call is voice, the VA may respond in voice. If chat or message the response must be text. At step 402 the VA sets up the responses to be voice or text accordingly.

At step 403 it is determined if the communicant (caller) is a fist time caller. If Yes, at step 404 the system sets up a customer profile for the caller. The profile bears an ID which may be such as the caller's telephone number, full name, address, a combination of these, or other unique identifier that can be associated with an incoming call to identify the caller. It is critical in embodiments of the invention that the identity be unique, and not capable of being confused with a different person or customer, because mistaken identity may have deleterious effects on operations in the system. This customer profile is central to the invention, is evolved over a plurality of calls and continuing interaction with a customer, essentially as a personality for the customer.

Following step 404, at step 405 for a new customer the call is managed by the VA by a default protocol, as there is at his point no developed profile for the new customer. In one embodiment of the invention there may be more than one default response protocol, and for a new customer, the area code may be used as a pointer to a default response protocol. If the area code is for New Orleans, for example, the default protocol may use in the VA voice an accent common to New Orleans. If the area code is for Boston, a Boston accent may be used in the VA's voice, and certain idioms native to the Boston area may be used. It should be noted that this personalization by region will be used just for communication with a fist time caller. For repeat callers with a history with the host enterprise the customer profile will be used instead.

At step 406 the VA causes communication characteristics of the customer to be monitored, such as the customer's speech analytics. This may be done by accent detection, monitoring rate of speech, noting speech style (teenager vs boomer and using words like OMG or not), noting voice pitch, volume, speech rate, use of idioms, gender, age, formal and informal speech, and more. These characteristics are recorded in the customer's profile, and may be updated in succeeding calls from the same customer. At the end of the call the stats are updated in the customer profile and the call is terminated.

If at step 403 it is determined that the call is not a first time call, at step 408 the VA accesses the customer's profile. At step 404 the VA manages the call according to the customer profile and history. It should be noted that this call may be a second call, and the history and the preferences in the profile may not be well-developed. Still, the stats recorded from the initial call may be used to manage the second call at step 409. At step 410 the VA monitors communication characteristics during the call, just as in the first-time call. This monitoring and updating is an ongoing process throughout all calls for a customer. At step 411 stats are updated and the call is terminated.

It is to be understood that personalization is a gradual process and evolves over succeeding customer calls. But personalization is applied in every case. Personalization starts with low to zero information that produces low to zero personalization. As a particular customer continues to interact with the business, more information is collected to make personalized decisions and more information is applied. Moreover, feedback about personalization is collected from the customer and this feedback reduces or increases personalization based on what the customer says she likes or does not like. Degree of personalization is gradual. It starts with low to zero information that produces low to zero personalization. As a particular customer continues to interact with the business, more information is collected to make personalized decisions and more information is applied. Moreover, feedback about personalization is collected from the customer and the feedback reduces or increases personalization based on what the customer says she likes or does not like.

In interacting with customers, the VA may at appropriate times in a conversation query the customer as to his or her preferences, and the answers would be added to that customer's profile for future use. Further, business outcomes may play a role. Statistics may be recorded as to what sort of personalization tends to increase probability of sale and customer returns, and personalization may be influenced accordingly. If a customer seems to be upset the personalization may tend to a soothing response.

The VA in embodiments of the invention detects the style of customer conversation and adjusts accordingly. A few examples: if a customer says: “OMG!!!! I absolutely love your Allbirds” AI might answer: “We're so thrilled to hear that!! We're absolutely pumped that you love your Allbirds—they're made to be comfy, stylish, and sustainable just for awesome folks like you! Thanks for the love!”. And if a customer says: “after some extensive research I have concluded that your airbirds shoes are the most applicable to me” then AI might answer:: “Thank you so much for your thoughtful research! We're delighted to hear that our Airbirds shoes are the right fit for you. They're crafted with care to provide comfort, quality, and a touch of sustainability. We hope you enjoy them as much as we do!”. Keep in mind that by “collecting feedback from customer” it is not meant the VA asks the customer about anything. The VA analyses style, tone, and detects most influential things.

In embodiments of the invention results are analyzed and compared over different protocols with personalization, with different degrees of personalization, and without personalization. Results of such comparisons may be used to adjust method and degree of personalization. Surveys are not used in processes of the invention.

### EXAMPLE I

A call is received, and it is determined that the caller is a first-time customer (see FIG. 4 step 403). It is noted that “deep” personalization requires repeat contact and experience with a customer, developing the customer profile. However, some personalization may be applied immediately.

(a) The VA notes the phone number or address and associates that with a city or other geographic region and selects a greeting from a plurality of pre-programmed greetings. The selection may or may not be influenced by geography. The VA may greet the customer: “Good Afternoon, and welcome to Acme Tools, the made-in America source of the best in automotive tools”. The VA leverages generative AI and in this case the accent, rate of speech, volume, and so on, may be generic to American English. A male voice may be used if the caller is identified as female, or a female voice if the caller is identified as male. Further, the geographic area might enable the VA to apply an accent common to the customer, in this case a southern creole accent. This is hit-or-miss however, as the customer calling from New Orleans may actually be from Manitoba, Canada, and vacationing in New Orleans. Likely best to wait until the customer's voice may be analyzed.

Another possible personalization without having heard the customer speak, but knowing the geographic source of the call might be to refer to weather in the region. This might only be done if there is known that an unusual weather phenomenon is occurring in that region. For example, if there is a heavy rainstorm in the New Orleans at the time, the VA might add in the greeting: “We certainly hope you're staying out of the rain.”

(b) The system initiates a customer profile for the new customer and establishes a unique ID for the customer. At this point the VA does not know the customer's name and may identify the new customer profile with the origin phone number. This will be updated with full name and other identifying characteristics as communication continues. It is noted that this occurs in the background and does not delay or interrupt the dialogue between the VA and the customer. To speed up the process of identity, the VA might add in the greeting something like: “To whom do I have the pleasure of speaking this rainy morning (afternoon, evening). If this is added in the greeting, the response is added to the CP identity right away.

(c) Assume the selected greeting is: “Good Afternoon, and welcome to Acme Tools, the made-in America source of the best in automotive tools. To whom do I have the pleasure of speaking with this rainy afternoon?” The caller speaks: “I'm Michelle Bassenger”. The VA adds the name to the new CP, with the phone number, including the area code.

(d) the VA continues: “Hi Michelle. How may we best serve you today?” During the dialogue, when the customer speaks, the VA is noting and recording voice characteristics (see FIGS. 3, 303).

(e) there are a variety of ways the conversation might continue. In this example with the host Acme Tools, the customer may inquire about a particular oil fiter wrench, and the VA may check inventory, take an order, and either redirect the customer to a sales dialogue, or continue and accept payment. This process may comprise the conventional steps of taking a credit card number, etc. The VA leverages the generative AI ability to make appropriate responses to the customer's statements and questions, and in every case applies the current personalization.

### EXAMPLE II

A call is received, and it is determined that the caller is a repeat customer (see FIG. 4 step 403). This customer has a well-developed CP and the VA immediately applies the personalization that is enabled by the customer profile.

(a) The VA checks the customer's CP, and notes from Purchase History 303, FIG. 3, that the customer, in the last call, purchased a hydraulic jack. The VA leverages generative AI to say: “Hi Bob. I see you bought our heavy-duty hydraulic jack last time you were here. Has that worked out for you?”

(b) in this example the customer may go on to ask about other products, and may or may not make another purchase. The VA applies personalization according to the well-Developed CP.

The skilled person will understand that the present invention is not limited to enterprises that are selling products online, just because such enterprises are described in examples. A VA according to the present invention leveraging generative AI to produce the host side of dialogue may be applied to many other circumstances in which a host is fielding calls from persons for whatever reason.

Further to the above, the VA and its function according to embodiments of the invention is not limited to voice interactions. Referring back to FIG. 1 it may be seen that IP-enabled devices and mobile devices may be used in communicating with a host using a VA according to the invention, and the communication may well be text, such as a chat session or a messaging application. These communications would come to contact center 115 through eServices server 117.

It will be apparent to the skilled person that in the circumstance of text communication personalization by voice preferences as shown in FIG. 3, element 306, is not applicable. In the case of text communication personalization may lean more heavily on background info 307 (FIG. 3). Generative AI may still be leveraged to produce text strings for the VA's contributions to the dialogue. For example, the VA, when a chat or text message comes in, may identify the customer and use the customer's profile to initiate a greeting, and the greeting may include personalization according to geographic region deduced by phone number or address, such as mentioning the weather in the customer's region, or activity of an NBA team, for example. The VA may also check call history, purchase history, and conversation history in formulating a personalized greeting.

Another function of the VA has to do with payment history, which may be referenced for every call or text incoming, The VA may, for example, be flagged that the customer calling is a VIP customer whose payment history indicates the customer pays immediately and may be a major purchaser. The VA may personalize greetings, comments and the like accordingly. In another circumstance the VA may identify the caller and note that the payment history says this customer has a large standing balance that has gone unpaid. In this circumstance the VA may bring this situation to the front and guide the dialogue to receive a payment or promise, and may decide not to sell to the customer, that would increase the outstanding balance.

The skilled person will realize that all of the embodiments described are exemplary and are not limiting to the scope of the invention. There are a variety of alternative ways that data may be collected, accessed and used, all within the scope of the invention. The invention is limited only by the claims that follow.

1. A method of producing a positive customer experience (CX), comprising:
receiving an incoming communication from a customer by a software-enabled Virtual Assistant (VA) in a contact center, initiating a dialogue;
identifying by the VA a unique identity for the customer;
preparing and delivering a greeting to the customer by the VA, the greeting comprising one or more elements reflecting a circumstance or characteristic of the customer;
continuing by the VA to personalize VA contributions to the dialogue until terminating the dialogue; and
if the communication is voice, monitoring contributions to the dialogue by the customer for voice characteristics, storing determined characteristics in a customer profile (CP) dedicated to the person.

2. The method of claim 1 wherein the incoming communication is from a new customer, comprising determining a unique identity for the customer and setting up the customer profile.

3. The method of claim 2 further comprising evolving the customer profile for the customer over time by storing call history, purchase history, payment history, and a conversation history.

4. The method of claim 1 wherein the voice characteristics comprise one or more of volume, speech rate, use of idioms, gender, age, and formal or informal speech.

5. The method of claim 4 further comprising storing background information associated with the customer, the background information comprising one or more of political affiliation, religion, geographic region, level of education, alma mater, weather in region, and local sports teams.

6. The method of claim 5 further comprising executing background searches on the Internet network finding and storing in the customer's CP the background information returned in the searches.

7. The method of claim 5 further comprising continuing over subsequent communications from the same customer to monitor the customer's contributions to the dialogue for personal characteristics and storing determined personal characteristics in the customer's CP.

8. The method of claim 5 further comprising continuing over subsequent communications from the same customer to personalize the VA's contributions to the dialogue by reference to the customer's CP, using one or more generative artificial intelligence (AI) algorithms.

9. The method of claim 1 wherein the communication is voice communication, comprising generating VA contributions as electronic signals suitable for telephony transmission.

10. The method of claim 1 wherein the communication is text, comprising generating VA contributions as text signals suitable for network transmission.

11. A system for producing a positive customer experience (CX), comprising:
a software-enabled Virtual Assistant (VA) in a contact center, initiating a dialogue with a customer initiated by an incoming communication from the customer;
a customer profile associated with the customer, originated at a first call from the customer, and associated with a unique identity for the customer;
wherein the VA delivers a greeting to the customer, the greeting personalized by comprising one or more elements reflecting a circumstance or characteristic of the customer, wherein the VA continues to personalize VA contributions to the dialogue until terminating the dialogue, and wherein the VA, if the communication is voice, monitors contributions to the dialogue by the customer for voice characteristics, storing determined characteristics in a customer profile (CP) dedicated to the person.

12. The system of claim 11 wherein the incoming communication is from a new customer, and the VA determines a unique identity for the customer and sets up the customer profile.

13. The system of claim 12 wherein the customer profile is evolved over time and subsequent calls from the same customer by storing call history, purchase history, payment history, and a conversation history.

14. The system of claim 11 wherein the voice characteristics comprise one or more of volume, speech rate, use of idioms, gender, age, and formal and informal speech.

15. The system of claim 14 wherein background information associated with the customer is stored in the CP, the background information comprising one or more of political affiliation, religion, geographic region, level of education, alma mater, weather in region, and local sports teams.

16. The system of claim 15 further comprising a search engine executing background searches on the Internet network, finding and storing in the customer's CP the background information returned in the searches.

17. The system of claim 15 wherein the VA continues over subsequent communications from the same customer to monitor the customer's contributions to the dialogue for personal characteristics and stores determined personal characteristics in the customer's CP.

18. The system of claim 15 wherein the VA continues over subsequent communications from the same customer to personalize the VA's contributions to the dialogue by reference to the customer's CP, using one or more generative artificial intelligence (AI) algorithms.

19. The system of claim 11 wherein the communication is voice communication, and the VA generates VA contributions to the dialogue as electronic signals suitable for telephony transmission.

20. The system of claim 11 wherein the communication is text, wherein the VA generates VA contributions to the dialogue as text signals suitable for network transmission.
